(19) United States
(12) Patent Application Publication
(10) Pub. No.: US 2003/0111744 A1
(43) Pub. Date: Jun. 19, 2003

(54) Device for guiding the flow of a liquid used for material and/or energy exchange in a wash column

(76) Inventor: Rolf P.C. Manteufel, Bad Harzburg (DE)

Correspondence Address: Reising Ehtington Barnes Kisselle, Learman & McCulloch, 5291 Colony Drive North, Saginaw, MI, 48603, US

(21) Appl. No.: 10/276,735

(22) PCT Filed: May 18, 2001
(86) PCT No.: PCT/EP01/05735

(51) Int. Cl. B01F 3/04

(52) U.S. Cl. 261/94; 261/97; 261/110; 261/DIG. 72

(57) ABSTRACT

The invention relates to a wash column for material and/or energy exchange between media, especially between a liquid trickling down and a gas or a lighter liquid rising in a counter-current. The invention especially relates to a novel structural packing that comprises liquid guide elements (19) in the form of wires or threads that form substantially rhomboid masses with vertical axes in imaginary surfaces (21) and that surround, for example in a polygonal grid, substantially free, vertical flow channels (22) for the counter-flowing gas. The nodes (18) of the liquid guide elements (19) are located at the respective points of intersection of a horizontal cross-section grid. The distance between the guide elements or the size of the meshes is chosen such that the liquid does not form film curtains and flows off only in defined flows, linearly along the guide elements (19). At the ends of the packing, the guide elements (19) for the introduction of liquid and for the draining-off of liquid are bundled step-wise to common strands for introducing or draining off liquid.

The invention concerns a device for guiding the flow of a liquid in a generally vertical direction used for material and/or energy exchange in a wash column according to the pre-characterizing portion of patent claim 1.

In the case of exchange elements used for material and/or energy exchange, filling bodies are more and more being offered as alternatives to exchange trays, which have been used for centuries. The purpose is to achieve an enlargement of the phase-interfacial area that determines the separation effect, and to make use of the more advantageous counter-current, rather than the cross-current that is usual with exchange trays.

At the same time an enlargement of the available surface of the individual filling bodies is sought by means of a reduction in the volume of the filling body. Volume is cubed while surface is squared, so that the available surface increases along with the number of filling bodies.

The filling body also becomes more compact while at the same time the free volume stays smaller in the reaction chamber and the flow channels are increased. The result is an increase in pressure loss (Δp/m), for example of the counter-flowing gas, and a greater energy exchange.

Attempts have been made to improve the separation effect by improving the design of the filling bodies and through variability in the construction materials. Due to the unclear flow conditions within filling bodies, structured packings were developed in which flow spaces of equal size are formed by plates arranged next to each other.

To evenly distribute the flow of gases and liquids over the packing cross-section, the liquid must be distributed evenly over the available exchange surfaces and be drained off uniformly. It has been shown however that it is not practically possible to distribute and drain off liquids evenly over surfaces. Attempts have been made to improve the wetting by using various surface designs or fabrics, but the liquid film determining the material and/or energy exchange and therefore the phase-interfacial area does not match the available exchange surface.

This occurs increasingly as the surface of the exchange elements increases, so that the specific surface needed for exchange increases more and more. The deterioration of the separation effect in exchange elements is termed micro and macroscopic maldistribution (uneven distribution of phases).

Even known film wash columns having bundles made of plates or tubes, in which the guided counter-flowing phases flow by one another unhindered, were not able to bring about the desired increase in effect. Since the liquid can no longer be radially distributed and mixed in the packings when the flow spaces are divided, introduction of the liquid at the top of the wash column is determinative for the separation effect.

It is especially difficult to distribute liquids evenly over a large number of plates and tubes. Due to the surface tension of liquids, de-wetting episodes and rivulets are matters of concern, along with varied drainage speeds, all leading to greater deterioration of the separation effect.

In sum, this means that structured packings differ from one another only minimally in their effectiveness, and are limited in their use because of disadvantageous surface construction. Hence, for economic reasons, they have not been able to supercede the floor constructions that have been known for centuries, which moreover have been somewhat improved in recent decades.

Taking into account the state of the art and basic research in the field of material and/or energy exchange, as well as the needs of the engineering profession, it is the aim of the present invention to provide better-performing exchange elements for more advantageous economic application in the chemical and allied industries.

By contrast with the previous focus on making improvements in the separation-effect/unit-length ratio, it has been acknowledged that it is more advantageous, for purposes of flow rate and production increases, to develop low-loss exchange elements with the smallest possible pressure-loss/unit-length ratio (Δp/m).

Since patent applications DE 100 24 142 and DE 100 51 523 have demonstrated ways to distribute liquid evenly over as many intake points of a cross-section surface as desired, an optimal fluid dynamic dimensioning of the exchange elements is possible.

A reaction packing in the form of a grid structure made of threads or wires has already been described in the parallel DE 100 24 142, in which quasi-identical hollow spaces in the structure are distributed evenly over the packing and in which there is no provision for preferred flow channels for the counter-flowing gas phase for example. On the contrary, the wire or thread structure evenly fills the packing space.

It is the goal of the present invention to provide an improvement in which the principle of the wash column is applied in a more thoroughgoing way, namely, so that the exchange surface between phases is as large as possible while at the same time the flow cross-sections are large and free, i.e., energy-intensive dynamic pressure is minimized, while the liquid does not trickle freely but rather follows pre-determined paths in even distribution.

This is possible because the guided counter-flowing phase is distributed over as many flow threads as possible, while the flow space remaining free in the reactor is completely available to the other phase.

For optimal flow conditions, structures of linear liquid-guiding elements, longitudinally spanning the reaction chamber, are provided in the form of wires or threads that form the borders of free flow-channels for the counter-flowing medium.

The distance between the wires or threads arranged next to each other is chosen so that the fluid that is trickling down or rising up along the threads or wires (e.g., in the event of extractions) cannot run together, but rather flows evenly around the wires or threads. This does not exclude the possibility of wires or threads coming together in nodes, together with their respective liquid streams, in order to allow the liquid to continue to flow, in like fashion, but in a new distribution, along those wires or threads as they depart from the node.

To continually renew the surface of the liquid, the wires or threads arranged next to each other are preferably crossed, i.e., brought together or interwoven at points, so that, because there are repeated flow-track beginnings, the separation-stage-count/unit-length ratio (NTSM) is increased, thus improving the material and/or heat exchange.

As is known, at this point the needed exchange surface is enlarged as the flow rate is increased. Also, the quantity of material and heat exchanged likewise increases as speed increases, although the exchange surface does not expand proportionally with the flow rate, but rather increases only exponentially (with an exponent <1).

As fluid moves along the wires or threads, the film thickness and at the same time the film surface grows along with the quantity of fluid draining off. This is not the case for flat surfaces since only the film thickness increases while the film surface remains unchanged. By contrast, with wires or threads, an increase in the flow rate is accompanied by an enlargement of the phase-interfacial area, and a reduction of the needed specific volume.

According to the inventor's idea, it will be increasingly possible to achieve great economic advantage by retrofitting production facilities to take advantage of the flow-rate increases made possible by the two aforementioned flow patterns.

In its most general form, the problem to be solved by the invention is solved by the characterizing features of patent claim 1.

The elements guiding the liquid through the device being claimed are named “linear liquid guide elements” or “guide elements” for short. They consist of threads or wires, or wires or threads that are bundled or combined from several of them (multi-fibered), or similar linear elements, along which a liquid can trickle down.

Some other definitions may be introduced: the core of the inventive device is the so-called “packing,” in which material and/or energy exchange takes place. The linear liquid guide elements, especially on the upper end, but also possibly on the lower end of the packing, are bundled together in groups, and step-wise where appropriate, for the distribution and injection of the liquid into the packing or for the collection of the liquid at the other end of the packing. The name of a self-contained unit that is made of the actual packing and the described structures for distributing or collecting the fluid is “exchange unit.” Such an exchange unit—including its liquid injection bundles consisting of linear liquid guide elements used to inject the liquid—is preferably attached to a drainage spout through which liquid coming from the pre-distributor can be directed into the individual bundles at a generally uniform hydrostatic pressure.

In contrast to previous proposals, the structure of the liquid guide elements in the packing according to the invention is designed so that the guide elements preferably lie in certain imaginary surfaces that together form borders around relatively free flow-channels for the counter-flowing medium. This does not exclude—nor should it exclude outright—the possibility that the counter-flowing medium may switch over into adjacent flow channels, and vice versa, by passing through the surfaces that contain the guide elements. The essential thing is that preferred flow channels are provided for the counter-flowing medium that result in less pressure loss, but that are separated by the surfaces covered with guide elements, so that it is guaranteed that the counter-flowing medium is well distributed as a matter of course. Nor is it essential that the preferred flow channels for the counter-flowing medium be completely free of liquid guide elements. For the sake of the structure of the packing, but also in order to optimize material and/or energy exchange, it may be reasonable to limit the unfettered free flow of the counter-flowing medium or to intentionally mount some liquid guide elements in the counter-flow channels.

As much as possible, guide elements should not be aligned horizontally in the imaginary surfaces, unless some horizontal stabilizing elements are needed for the stability of the packing. This means that the liquid guide elements run at an angle to the horizontal axis that may be greater than 45° because the general direction of flow through the packing is ultimately vertical. The liquid guide elements preferably cross each other in two oblique, opposed directions to maintain constant liquid re-distribution. The resulting structure consists of substantially rhomboid meshes having a vertical axis. The distance between the liquid guide elements, i.e., the size of the resulting meshes, is chosen so that the liquid intended to flow along them does not have a tendency to form film bridges between the guide elements, i.e., in the meshes. Such formation of a film or film curtain supported by guide elements in a vertical surface does not fall within the intentions of the present invention. On the contrary, it is an essential feature of the present invention that defined individual flows are conducted along the liquid guide elements through the packing and that open surfaces remain for the counter-flowing medium to spill over into adjacent flow channels.

In a very simple arrangement of the packing according to the invention, as a portion of the claimed device, the guide elements are arranged in parallel, spaced vertical planes intersecting each other crosswise and obliquely as much as possible or interwoven, so that longitudinal rectangular flow channels remain for the counter-flowing medium between these planes in cross-section. In any case, the flow channels in this embodiment are generally wider than they are thick, which latter is determined by the distance between the planes covered by guide elements. The guide elements of parallel planes can be connected to each other at intervals, especially if the stability of the packing requires it.

But preferable embodiments are those in which the imaginary surfaces covered with guide elements enclose individual vertical flow channels, especially ones that are radial-symmetric in cross-section. These flow channels have a prismatic constellation as a rule, whereby the imaginary surfaces containing liquid guide elements are the envelope surfaces of such a prism.

A special embodiment of the present invention involves envelope surfaces that surround a flow channel and that are curved in cross-section, especially exhibiting an elliptical or circular cross-section. This may be reasonable for reasons of manufacturing technique. The liquid guide elements in this case are spirals running preferably in two opposite directions in the pertinent cylinder envelope surface; the guide elements intersect in the crossing points. They can also be woven as nodes at the crossing points. It is conceivable that the guide elements may form a zigzag arrangement that ends up in the same structure, but the spiral format is easier to manufacture, technically speaking.

Several such tubes with guide elements arranged on cylinder envelope surfaces can now be arranged in a vertical group to form a packing; preferably, they make contact with each other. The contact areas can be formed as slight reciprocally flattening surfaces. In the contact areas, the guide elements of adjacent tubes are interconnected; the liquid can thus be redistributed between the individual units. A certain disadvantage of the cylindrical form is that wedge-shaped spaces are created between the adjacent cylinders that then form, as it were, flow channels of lesser cross-section.

To avoid this, the imaginary prisms with envelope surfaces occupied by guide elements have a polygonal cross-section. Adjacent prisms can have common partial envelope surfaces. In the case of prisms with triangular, rectangular, or hexagonal cross-section, a tight wedge-free cross-section structure of adjacent flow channels is created which are separated by the imaginary envelope surfaces decked with liquid guide elements.

The resulting cross-section is a regular polygonal grid, the lines of which are the cross-section lines of the imaginary vertical surfaces. The linear liquid guide elements are formed in such a way that they form nodes in the intersections of the grid lines of such a structure; more nodes are present at a fixed vertical distance that form an identical, adjacent, cross-sectional plane of the same grid. Two adjacent nodes of a grid plane form a rectangle with both corresponding nodes of the next grid plane. The liquid guide elements are now preferably placed so that each guide element runs obliquely from one of the two adjacent nodes to the other node of the adjacent grid plane, so that these two guide elements cross in the said rectangular surface. The imaginary envelope surfaces of the prismatic construction of the packing are characterized by such crossing guide elements.

As already mentioned, guide elements can also be led from one node to a non-adjacent node in the next grid plane which then runs obliquely through the flow channel. This can be useful for controlling resistance to flow and also for redistributing the liquid.

A necessary condition for optimal functioning of the device is uniform injection of liquid, as mentioned at the beginning; to this end, in the preferred embodiment, the guide elements running through the reaction chamber are gathered in bundles in multiple stages and then attached at the liquid injection points to drainage spouts.

Uniform slits are created where the bundles of guide elements positioned around fixing pins are led through perforated disks. In a preferred embodiment, these uniform slits are made by clamped round bundles of guide elements, on the one hand, and perforation holes located at various radii on the perforated disks, on the other; contact is thereby made with the vertices so that sickle-shaped openings are formed around the rims of the guide element bundles.

The discharge spouts mounted next to one another are fed by a common pre-distributor. Uniform discharge quantities into the discharge spouts can then be achieved due to the concentrated arrangement of the discharge nozzles of the pre-distributor; installation deviations play no role in the discharge spouts.

Another advantage lies in the feeding of a large number of discharge spouts through a common pre-distributor while only the pre-distributor needs to be gimbal-mounted during mobile set-up, and even in this case the liquid is discharged evenly while maintaining an even liquid level in the pre-distributor.

To avoid liquid discharging on the inner wall of the reaction chamber, a diagonal fabric coordinated with the longitudinal guide elements can be usefully placed on the inner wall of the device or directly around the reaction packing for small dimensions.

The device is further explained according to the following drawings. These show:

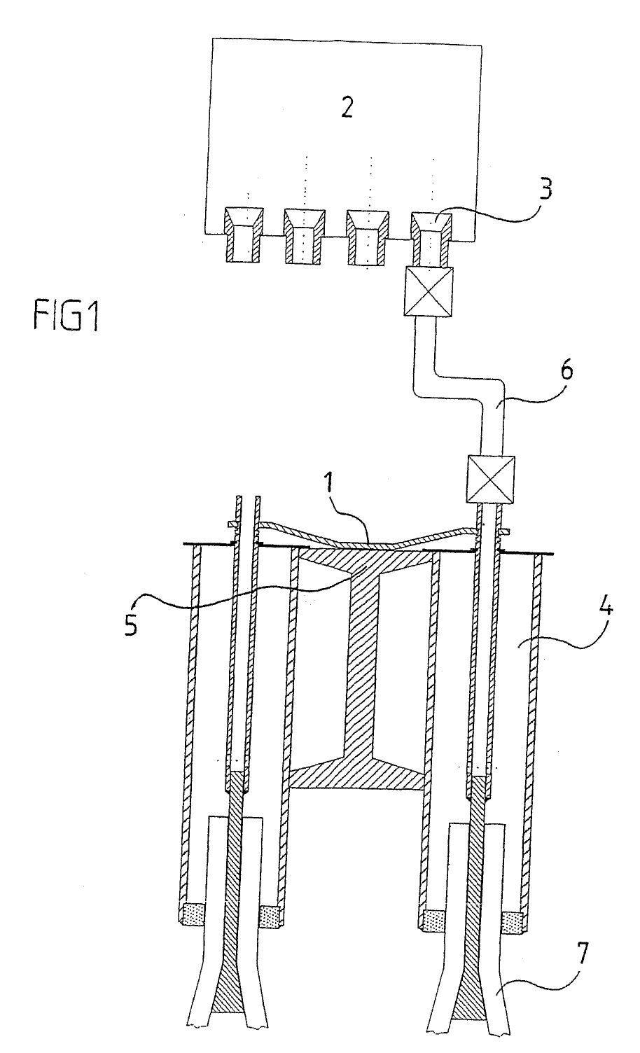

FIG. 1 a side-view of a liquid introduction device having a pre-distributor and discharge spouts mounted one after the other;

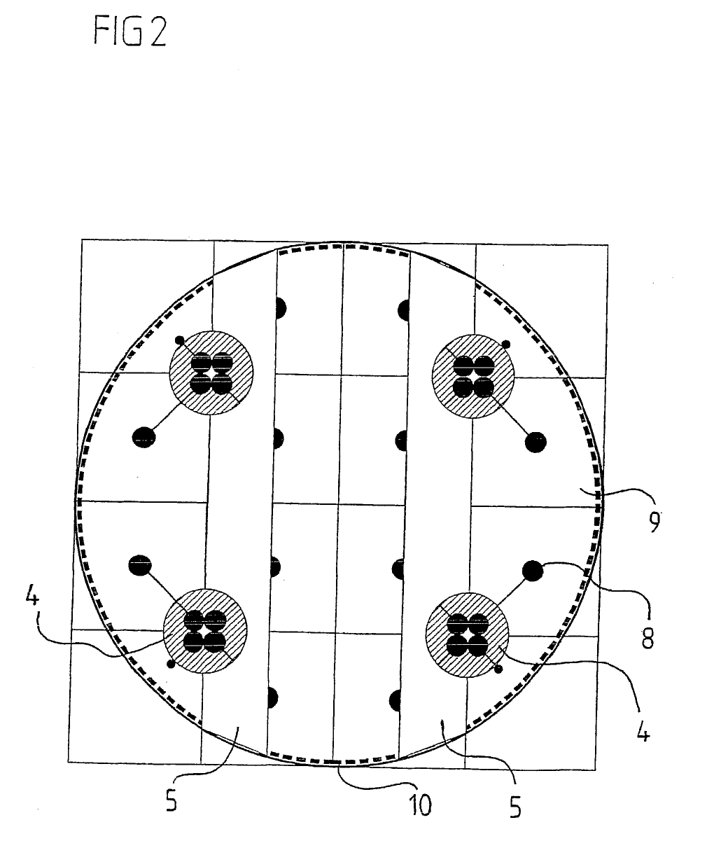

FIG. 2 a top-view of the discharge spouts from FIG. 1 mounted one after the other;

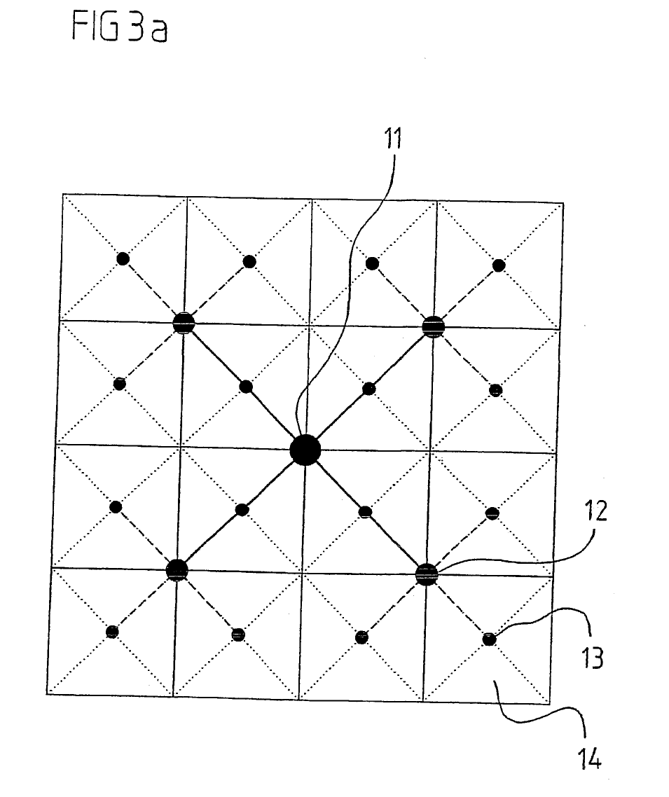

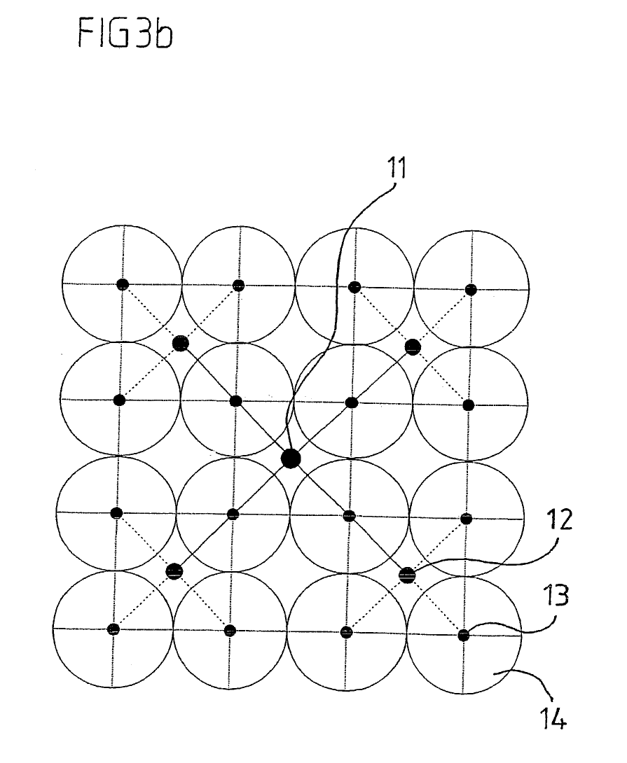

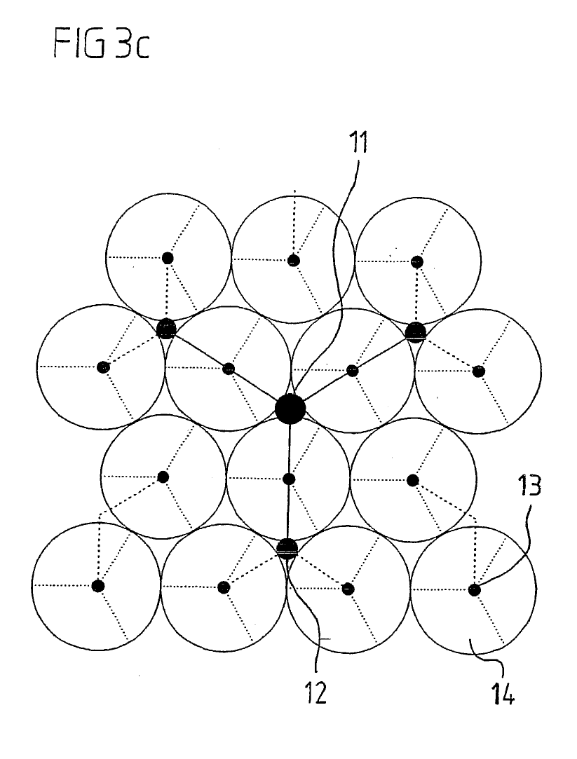

FIG. 3a a top-view of a quadratic grid cross-section of a reaction packing for step-wise liquid distribution;

FIG. 3b like FIG. 3a with round flow channels arranged next to one another;

FIG. 3c like FIG. 3b with round flow channels tightly arranged next to one another;

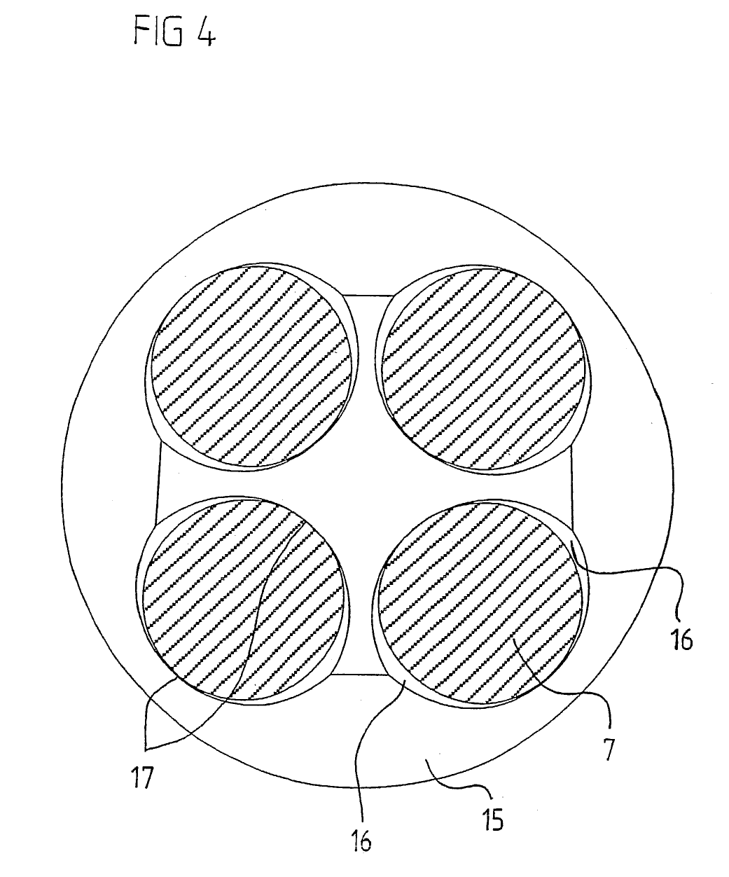

FIG. 4 a cross-section through a perforated disk of the discharge spout with liquid guide elements arranged within;

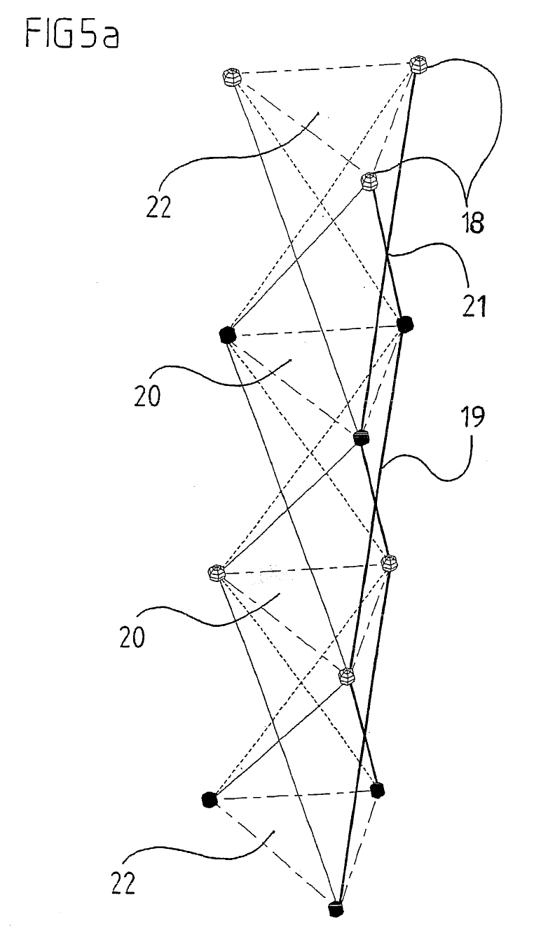

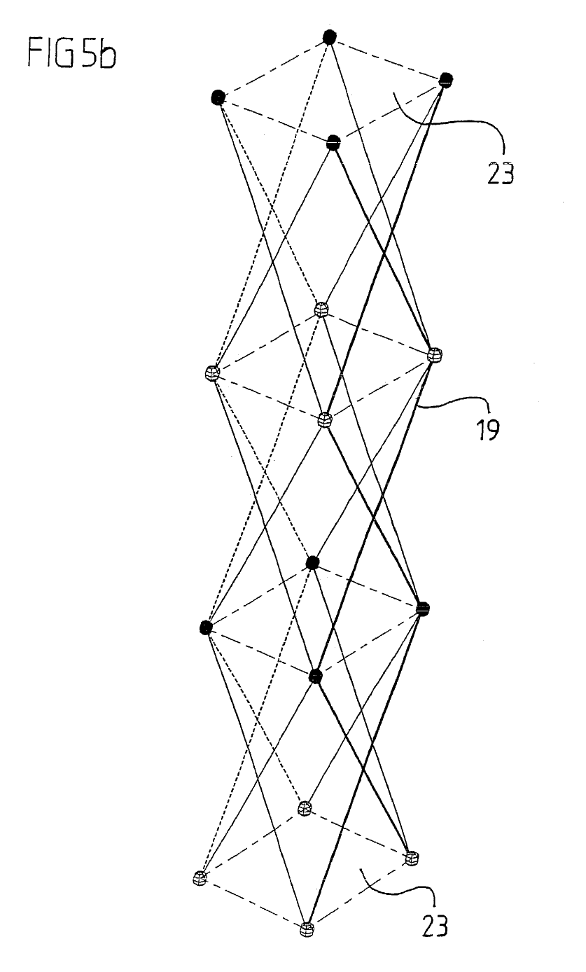

FIG. 5a a side-view of the liquid guide elements running around a quasi-triangular vertical flow channel;

FIG. 5b a side-view of the liquid guide elements running around a quasi-quadrilateral vertical flow channel;

FIG. 5c a side-view of the liquid guide elements running around a quasi-hexagonal vertical flow channel;

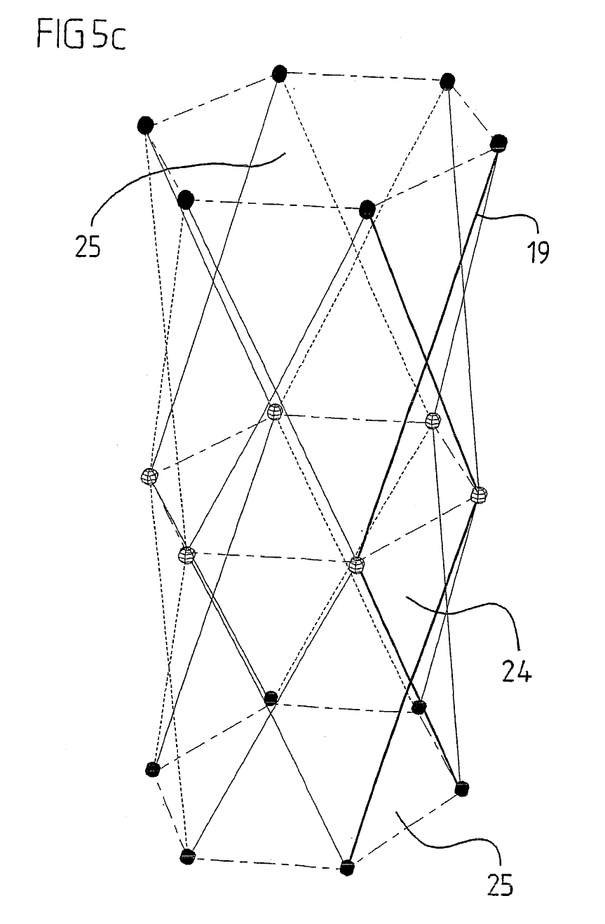

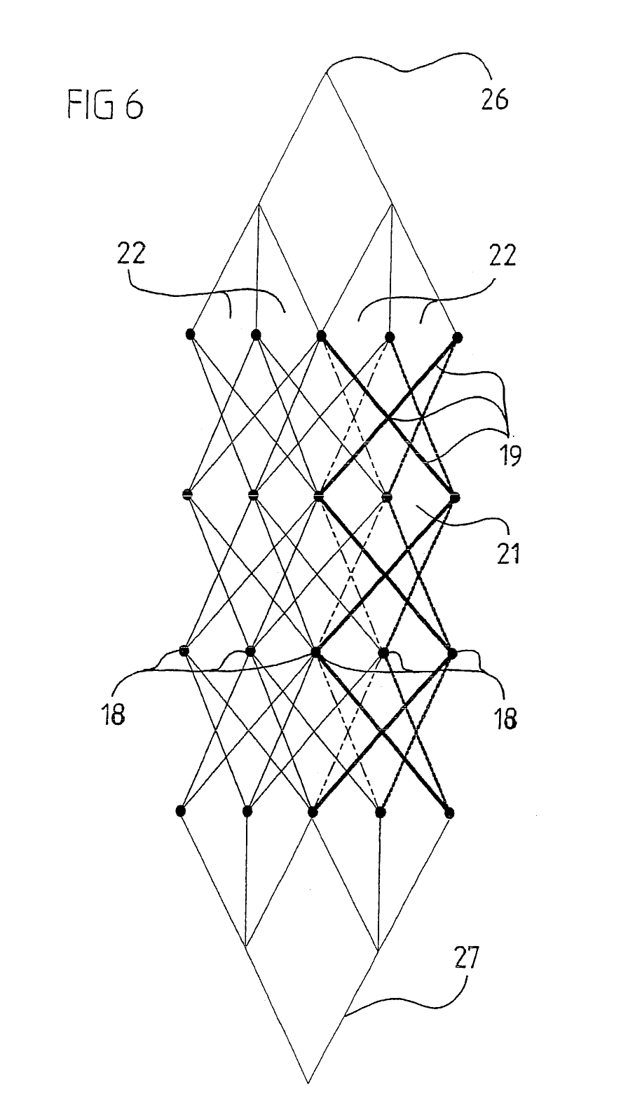

FIG. 6 a side-view of two quasi-triangular vertical flow channels arranged next to one another according to FIG. 5a with upper and lower step-wise combined liquid guide elements;

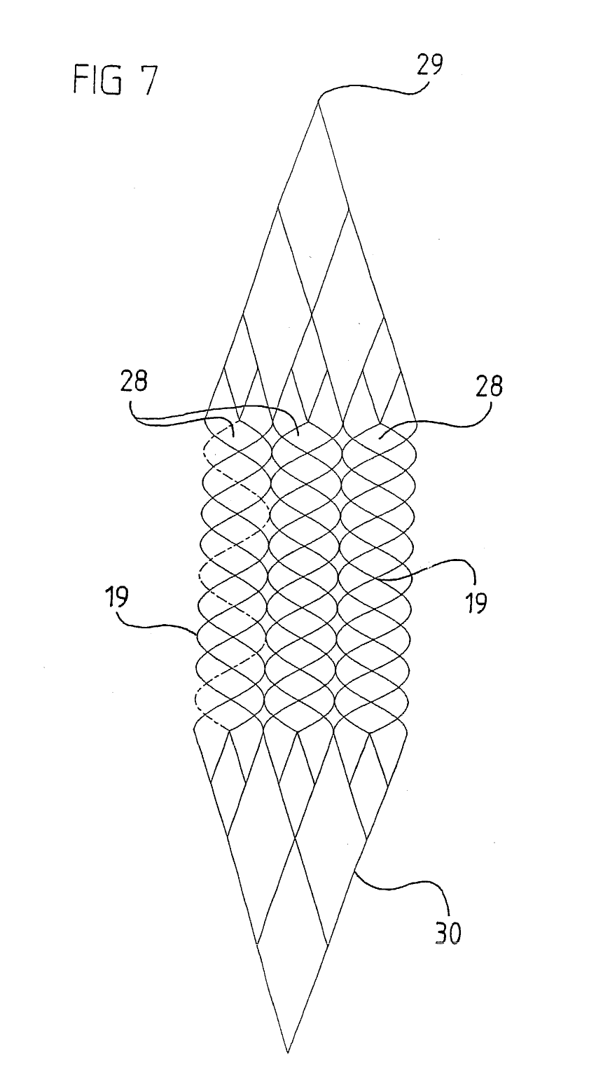

FIG. 7 like FIG. 6, but with three quasi-round vertical flow channels arranged next to one another with upper and lower step-wise combined liquid guide elements.

The arrangement for distributing liquid through a wash or reaction column is explained in FIGS. 1 and 2: FIG. 1 shows in a side-view a liquid intake device 1 having a pre-distributor 2 and discharge nozzles 3 arranged next to each other on the same plane.

Due to the separation of liquid intake between pre-distributor 2 and discharge spouts 4, the discharge quantities do not depend on installation deviations for discharge spouts 4; these can be mounted to supports 5 separated from the liquid intake device 1.

The same liquid quantities being discharged through the nozzles 3 through pipes or hoses 6 solely determine the liquid amount being discharged from the discharge spouts 4 via bundles of liquid guide elements 7 independent of any installation precision.

FIG. 2 shows the discharge spouts 4, which are distributed over intake positions 8 of the exchange elements 9 and are located on the supports 5.

To avoid edge spills of liquid, a fabric 10 is placed on the inner wall of the reaction chamber or around the exchange elements 9, or other guards are used.

FIG. 3a shows a top-view of principally step-wise liquid distribution of distribution points 11 of the discharge spouts 4 corresponding to distribution points 12, 13 on adjacent quadratic exchange elements 14.

FIG. 3b, similar to FIG. 3a, shows principally step-wise liquid distribution of distribution points 11 of the discharge spouts 4 corresponding to distribution points 12, 13 on neighboring round exchange elements 14.

FIG. 3c similar to FIG. 3b, shows principally step-wise liquid distribution, instead of four, in three directions from distribution points 11 of the discharge spout 4 to distribution points 12, 13 on closely adjacent round exchange elements 14.

FIG. 4 shows bundles of liquid guide elements 7 led through a perforated disk 15; uniform slits 16 are formed through various radii of a perforated disk 15; the bundles of liquid guide elements 7 are formed so that they make contact with their vertices 17 at the openings of the perforated disk.

FIG. 5a shows the liquid guide elements 19, which cross each other between the neighboring cross-section planes 20 and which are running longitudinally on the example of a triangular grid with corners 18. A quasi-triangular vertical flow channel 22 is formed through these crossing guide elements 19, which run longitudinally on the shell surfaces.

FIG. 5b, like FIG. 5a, shows quasi-quadratic vertical flow channel 23 formed from the crossing guide elements 19.

FIG. 5c shows the arrangement of crossing guide elements 19 on the six shell surfaces 24 of a hexagonal prism; the elements form a quasi-hexagonal vertical flow channel 25.

FIG. 6 shows a side-view of two adjacent quasi-triangular flow channels 22; the crossing guide elements 19 on the front shell surface 21 of the right triangular flow channels 22 is in bold print.

By a repeated parallel arrangement of the flow channels 22, a three-dimensional packing is formed. The guide elements 19 running longitudinally at the intersection of a triangular grid are combined above and below step-wise in bundles 26 and 27 of guide elements; the upper guide element bundle 26 is mounted in the described discharge spout.

FIG. 7, similar to FIG. 6, shows adjacent quasi-circular flow channels 28 with guide elements 19 crossing on the circumference of the flow channels 28; the elements are likewise combined above and below step-wise in bundles 29 and 30, and the upper bundle 29 is mounted in the described discharge spout.

1. Device for guiding the flow in a generally vertical direction of a liquid in a wash column, with linear liquid elements in the form of wires or threads or bundles made of wires or threads characterized in that the liquid guide elements run especially in imaginary surfaces that are substantially vertical, straight in the horizontal cross-section or not straight, for example bent, and the surfaces are borders for flow channels for the counter-flowing medium.

2. Device according to claim 1, characterized in that the liquid guide elements incline away from the horizontal in every section of their direction within their surface direction.

3. Device according to claim 2, characterized in that the liquid guide elements form a grid structure in their surfaces, while especially obliquely running liquid guide elements cross or generally vertical bundles of liquid guide elements are splayed to the side between nodes in individual guide elements and come into contact with corresponding individual guide elements of neighboring bundles.

4. Device according to at least one of claims 1-3, characterized in that the liquid guide elements have such a distance from one another or the grids have such a size so that the formation of film from a discharging liquid that fills the grids or spans the distance between neighboring guide elements is avoided.

5. Device according to at least one of claims 1-4, characterized in that the liquid guide elements run in parallel vertical surfaces and are borders in the cross-section for longitudinal rectangular flow channels for the counter-flowing medium.

6. Device according to claim 5, characterized in that the guide elements of the individual parallel surfaces are interconnected in intervals through cross-elements.

7. Device according to at least one of claims 1-4, characterized in that the surfaces containing the liquid guide elements are the shell surfaces of a vertical prism, whose inner space forms a flow channel for the counter-flowing medium.

8. Device according to claim 7, characterized in that the vertical prism has a bent cross section, especially the shell surfaces being those of an elliptical or circular cylinder and the liquid guide elements form spirals in this shell surface.

9. Device according to claim 8, characterized in that the liquid guide elements cross each other in opposing directions.

10. Device according to claims 8 or 9, characterized in that the shell surfaces of neighboring cylinders are in contact with each other in linear form or slightly flattened, with reciprocal contact of the liquid guide elements in these contact areas.

11. Device according to claim 7, characterized in that the shell surfaces of the prism are those of a prism having polygonal cross-section and especially having triangular, rectangular, or hexagonal cross-section.

12. Device according to claim 11, characterized in that the neighboring prisms form common partial shell surfaces.

13. Device according to claim 12, characterized in that the arrangement of a number of neighboring prism surfaces forms a three-dimensional structured packing having parallel equal flow channels for the counter-flowing medium that are bordered by the prismatic surfaces.

14. Device according to claim 13, characterized in that the packing in a cross-section plane forms a regular polygonal grid, whose grid lines are the cross-section lines of the surfaces containing the liquid guide elements, whereby nodes or crossing points of the liquid guide elements lie within the intersections of the grid lines and guide elements run from these nodes in the surfaces to the neighboring nodes in the intersections of next highest or next lowest cross-section plane.

15. Device according to claim 14, characterized in that liquid guide elements running in each case from two neighboring nodes in a cross-section plane to the other node in a neighboring cross-section plane are crossed in the surface containing these nodes.

16. Device according to claim 14 or 15, characterized in that, in addition to the liquid guide elements running in surfaces that act as borders to a flow channel for the counter-flowing medium, liquid guide elements are provided that run from a node of a cross-section plane through the flow channel diagonally to a node of a neighboring cross-section plane.

17. Device according to at least one of claims 1-16, characterized in that the liquid guide elements are combined on the upper and/or lower ends of the device into groups for distributing introduced liquid or for collecting discharged liquid.

18. Device according to claim 17, characterized in that the liquid guide elements are combined in groups in multiple stages.

19. Device according to claim 17 or 18, characterized in that the liquid guide elements being combined for liquid intake are mounted in inflow or outflow spouts.

20. Device according to claim 19, characterized in that the liquid guide elements are combined around fixing pins and led through perforated disks.

21. Device according to claims 19 and 20, characterized in that these uniform slits are formed on the one hand through surrounded round guide element bundles and on the other through various radii of the perforated disk, with the sleeves of the guide element bundles in contact with the vertices of the holes.

22. Device according to one of claims 19-21, characterized in that several of the discharge spouts mounted next to one another are connected to a common pre-distributor.

23. Device according to claim 22, characterized in that the pre-distributors are gimbal-mounted.

24. Device according to at least one of the preceding claims, characterized in that a diagonal fabric is located on the inner wall of the device or around the reaction packing.
